(19) United States
(12) Patent Application Publication
(10) Pub. No.: US 2022/0343527 A1
(43) Pub. Date: Oct. 27, 2022

(54) TIRE GROOVE MEASUREMENT DEVICE AND TIRE GROOVE MEASUREMENT METHOD

(71) Applicant: TOYO TIRE CORPORATION, Itami-shi Hyogo (JP)

(72) Inventors: Siyi REN, Itami-shi Hyogo (JP); Takaya MAEKAWA, Itami-shi Hyogo (JP); George LASHKHIA, Itami-shi Hyogo (JP)

(21) Appl. No.: 17/701,292

(22) Filed: Mar. 22, 2022

(30) Foreign Application Priority Data
Apr. 21, 2021 (JP) 2021-072090

(51) Int. Cl. G06T 7/60; G01B 11/24; G01M 17/02

(52) U.S. Cl. CPC G06T 7/60; G01B 11/24; G01M 17/027; G06T 2207/10012; G06T 2207/10048; G06T 2207/30252

(57) ABSTRACT

A tire groove measurement device includes a camera, a straightness calculation unit as a calculation unit, and a determination unit. The camera includes a projector for projecting a measurement pattern onto a tire and two imaging units arranged in the same direction as a direction in which a tire groove extends. The straightness calculation unit calculates how straight an outer surface of the tire and the camera face each other based on an image captured by the imaging units. The determination unit determines whether the outer surface of the tire and the camera face each other straight based on a result of calculation by the straightness calculation unit.

### CROSS-REFERENCE TO RELATED APPLICATION

This application is based upon and claims the benefit of priority from the prior Japanese Patent Application No. 2021-72090, filed on Apr. 21, 2021, the entire contents of which are incorporated herein by reference.

### BACKGROUND OF THE INVENTION

### 1. Field of the Invention

The present invention relates to a tire groove measurement device and a tire groove measurement method.

### 2. Description of the Related Art

Generally, wear of a tire progresses depending on the traveling condition, travel distance, etc. The degree of progress of tire wear is inspected by measuring the depth of a tire groove provided on the tread part. When the wear progresses to a certain degree or more, the tire is exchanged or regenerated.

JP2017-198672 A discloses a related-art device for measuring a condition of wear of a tire groove. The related-art device is provided with at least one illumination device designed to illuminate a portion of a tire subject to measurement, at least two cameras designed to detect an image of the portion of the tire illuminated by the illumination device, and an electronic unit designed to interpolate images of the tire received from the cameras. With this device, it is possible to measure a condition of wear of the tire groove and a parameter for the geometric shape of the tire such as runout and taper.

### SUMMARY OF THE INVENTION

JP2017-198672 A shows that the measurement device can measure the geometric shape of a tire groove, etc., using a stereoscopic view obtained by the two cameras arranged in the tire width direction. The related-art measurement device has a drawback in that, when the depth dimension of the tire groove is large and the camera is close to the tire, a blind area is created on the bottom of the tire groove in an image captured by the cameras, producing a measurement error in the depth of the tire groove.

The present invention addresses the issue and a purpose thereof is to provide a tire groove measurement device and a tire groove measurement method capable of improving the precision of measurement of the depth of the tire groove.

An embodiment of the present invention relates to a tire groove measurement device. A tire groove measurement device includes: a camera that includes a projector for projecting a measurement pattern onto a tire and two imaging units arranged in the same direction as a direction in which a tire groove extends; a calculation unit that calculates how straight an outer surface of the tire and the camera face each other based on an image captured by the imaging units; and a determination unit that determines whether the outer surface of the tire and the camera face each other straight based on a result of calculation by the calculation unit.

Another embodiment of the present invention relates to a tire groove measurement method. A tire groove measurement method includes: imaging, by two imaging units in a camera, an outer surface of a tire by projection from a projector in the camera, the imaging units being arranged in the same direction as a tire groove, and the projector projecting a measurement pattern onto the tire; calculating how straight the outer surface of the tire and the camera face each other based on an image captured in the imaging; and determining whether the outer surface of the tire and the camera face each other straight based on a result of calculation by the calculating.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram for illustrating a condition of use of a tire groove measurement device according to the embodiment;

FIG. 2 shows an appearance of the tire groove measurement device according to the embodiment;

FIG. 3 is a block diagram showing a functional configuration of the tire groove measurement device;

FIG. 4A is a schematic diagram showing the relative positions of the tire and the camera in a side view of the tire, and FIG. 4B is a schematic diagram showing the relative positions of the tire and the camera in a cross-sectional view of the tire;

FIG. 5 is a schematic diagram showing an arrangement of the imaging units in the tire width direction by way of a comparative example;

FIG. 6 is a flowchart showing a sequence of steps for measuring the depth of the tire groove by the tire groove measurement device; and

FIG. 7 is a schematic diagram showing an appearance of the tire groove measurement device according to a variation.

### DETAILED DESCRIPTION OF THE INVENTION

The invention will now be described by reference to the preferred embodiments. This does not intend to limit the scope of the present invention, but to exemplify the invention.

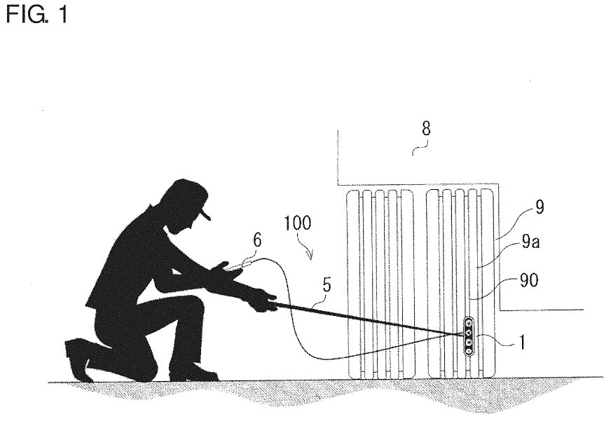

Hereinafter, the invention will be described based on preferred embodiments with reference to FIGS. 1 through 7. Identical or like constituting elements and members shown in the drawings are represented by identical symbols and a duplicate description will be omitted as appropriate. The dimension of members in the drawings shall be enlarged or reduced as appropriate to facilitate understanding. Those of the members that are not important in describing the embodiment are omitted from the drawings.

### Embodiment

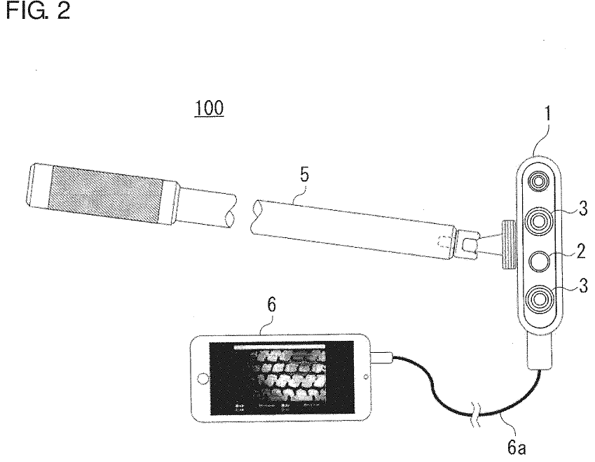

FIG. 1 is a schematic diagram for illustrating a condition of use of a tire groove measurement device 100 according to the embodiment, and FIG. 2 shows an appearance of the tire groove measurement device 100 according to the embodiment. The tire groove measurement device 100 measures the depth of a tire groove 90 provided in a tread part 9a of a tire 9 mounted on a vehicle 8. The tire groove 90 is formed to extend in the tire circumferential direction.

The tire groove measurement device 100 is provided with a camera 1, a support 5, and a measurement unit 6. The camera 1 has a projector 2 for projecting light formed by a predetermined pattern onto the tire 9 as a measurement pattern. The camera 1 also has two imaging units 3. The two imaging units 3 are arranged at an interval. The imaging unit 3 images the tread part 9a while the projector 2 is projecting a measurement pattern onto the tread part 9a of the tire 9.

The support 5 has a rod shape, and the camera 1 is attached to one end of the support 5. A worker holds the other end of the support 5 with the hand and measures the depth of the tire groove 90 by causing the camera 1 provided at the one end of the support 5 to face the tire 9 straight.

The measurement unit 6 is communicably connected to the camera 1 by wire or wirelessly. The measurement unit 6 acquires image data output by the camera 1 and calculates the depth of the tire groove 90 based on the image data. FIG. 2 shows that the measurement unit 6 is provided to be separate from the support 5 and connected to the camera 1 by a signal cable 6a. Alternatively, the measurement unit 6 may be attached to the other end of the support 5. The signal cable 6a may not be provided. The camera 1 and the measurement unit 6 may be communicably connected wirelessly.

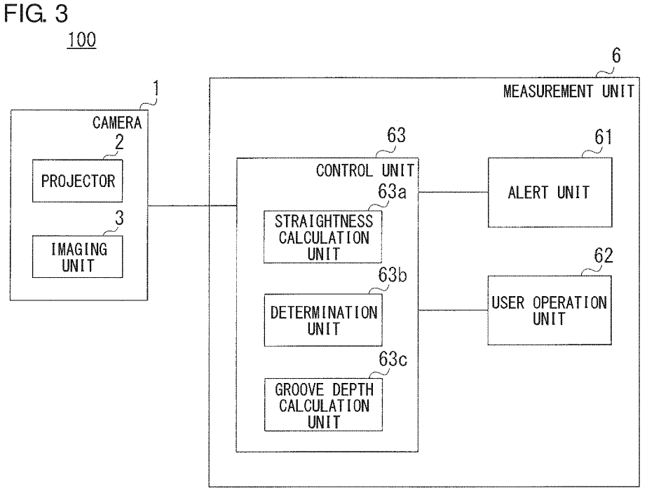

FIG. 3 is a block diagram showing a functional configuration of the tire groove measurement device 100. As described above, the camera 1 of the tire groove measurement device 100 has the projector 2 and the two imaging units 3. The camera 1 images the tread part 9a by means of the imaging unit 3 while the projector 2 is projecting a measurement pattern onto the tread part 9a of the tire 9.

The measurement unit 6 has an alert unit 61, a user operation unit 62, and a control unit 63. The parts in the measurement unit 6 can be implemented in hardware such as electronic devices or mechanical components exemplified by a CPU of a computer, and in software such as a computer program. FIG. 3 depicts functional blocks implemented by the cooperation of these elements. Therefore, it will be understood by those skilled in the art that the functional blocks may be implemented in a variety of manners by a combination of hardware and software.

The alert unit 61 is, for example, a display device such as a liquid crystal display. The alert unit 61 alerts a worker of measurement related information such as a result of measurement of the depth of the tire groove 90 and of guidance information related to the user operation of the worker, by displaying the information on the display device. The alert unit 61 may display an image of the tread part 9a of the tire 9 being imaged.

The alert unit 61 also alerts the worker that measurement of the tire groove 90 is possible. The alert unit 61 displays, for example, a colored mark in a circular shape, etc. on the display device. The alert unit 61 alerts the worker that measurement of the tire groove 90 is possible by changing the color of the mark to a color indicating that measurement is possible. A determination that measurement of the tire groove 90 is possible is made by a determination unit 63b of the control unit 63, as described later. The alert unit 61 alerts that measurement of the tire groove 90 is possible based on a result of determination by the determination unit 63b.

The alert unit 61 may have a speaker, etc. in addition to the display device for visual display and may alert the worker that measurement of the tire groove 90 is possible with a sound. An alert from the alert unit 61 to indicate that measurement of the tire groove 90 is possible may not be limited to display on the display device or sound output from the speaker.

The user operation unit 62 is an input device such as a touch panel and a switch that can be manipulated. The user operation unit 62 acknowledges a user operation input related to measurement of the depth of the tire groove 90 based on a user operation by the worker. The user operation unit 62 outputs the user operation input acknowledged to the control unit 63.

The control unit 63 has a straightness calculation unit 63a, a determination unit 63b, and a groove depth calculation unit 63c. The control unit 63 acquires image data for the tread part 9a of the tire 9 imaged by the camera 1 and calculates the depth of the tire groove 90 based on the image data.

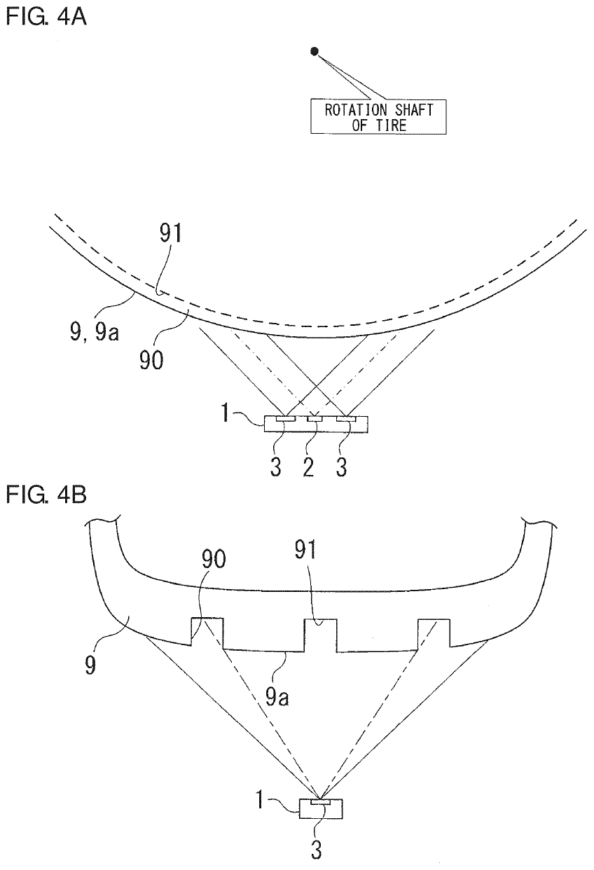

The straightness calculation unit 63a calculates how straight the outer surface of the tread part 9a and the camera 1 face each other by referring to the image data captured by the two imaging units 3 of the camera 1. FIG. 4A is a schematic diagram showing the relative positions of the tire 9 and the camera 1 in a side view of the tire 9, and FIG. 4B is a schematic diagram showing the relative positions of the tire 9 and the camera 1 in a cross-sectional view of the tire 9. FIG. 4B shows a cross section including the rotation shaft of the tire 9. The camera 1 is arranged such that the two imaging units 3 of the camera 1 are arranged at an interval in the circumferential direction of the tire 9. The straightness calculation unit 63a corresponds to the calculation unit of the invention.

Each imaging unit 3 images the tread part 9a of the tire 9 irradiated by the projector 2 with the measurement pattern. The straightness calculation unit 63a calculates the three-dimensional position of the outer surface of the tread part 9a (geometric shape of the outer surface) according to the principle of a stereo camera, based on the image data captured by the two imaging units 3 of the camera 1. A publicly known technology such as distance measurement based on the principle of a stereo camera may be used in the straightness calculation unit 63a to calculate the three-dimensional position of the outer surface of the tread part 9a.

Referring to FIG. 4B, the two imaging units 3 are arranged in a direction perpendicular to the paper surface. Therefore, the blind area as viewed from the imaging unit 3 is reduced, or there are no blind areas, at least in the tire groove 90 in the front direction as viewed from the imaging units 3. Since the two imaging units 3 are arranged at an interval in the tire circumferential direction, an image is captured such that the blind area in a bottom part 91 of the tire groove 90 as viewed from the imaging units 3 is reduced.

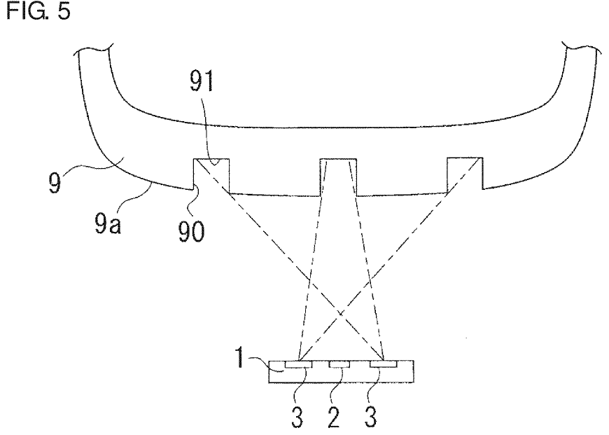

FIG. 5 is a schematic diagram showing an arrangement of the imaging units 3 in the tire width direction by way of a comparative example. In this case, a blind area is created on the bottom part 91 when the tire groove 90 is viewed from the two imaging units 3. A blind area created on the bottom part 91 as viewed from the two imaging units 3 makes it difficult to calculate the stereoscopic shape of the tire groove 90 accurately, which has been a factor to reduce the precision of calculation of the depth of the tire groove 90.

The straightness calculation unit 63a calculates how straight the outer surface of the tire 9 and the camera 1 face each other by calculating the amount of displacement of the normal direction of the outer surface of the tread part 9a relative to the front direction facing the camera 1. The straightness calculation unit 63a outputs the amount of displacement of the normal direction of the outer surface of the tread part 9a to the determination unit 63b.

The straightness calculation unit 63a can also calculate a distance between the camera 1 and the outer surface of the tread part 9a in the front direction facing the camera 1 by calculating the three-dimensional position of the outer surface of the tread part 9a. The straightness calculation unit 63a outputs the calculated distance to the determination unit 63b.

The determination unit 63b determines whether it is possible to measure the depth of the tire groove 90 based on how straight the outer surface of the tire 9 and the camera 1 face each other, i.e., the amount of displacement of the normal direction of the outer surface of the tread part 9a relative to the front direction facing the camera 1. The determination unit 63b may determine that it is possible to measure the depth of the tire groove 90 when the amount of displacement of the normal direction of the outer surface of the tread part 9a relative to the front direction facing the camera 1 is smaller than a predetermined value (e.g., a value of about 1°-10°).

The determination unit 63b may decompose the amount of displacement of the normal direction of the outer surface of the tread part 9a relative to the front direction facing the camera 1 into the amount of displacement in the tire width direction and the amount of displacement in the tire circumferential direction and may make a determination by comparing the respective component with predetermined values. In this case, the predetermined values for checking the amount of displacement in the tire width direction and the amount of displacement in the tire circumferential direction may be different values.

The determination unit 63b may determine whether it is possible to determine the depth of the tire groove 90 based on a distance between the camera 1 and the outer surface of the tread part 9a in the front direction facing the camera 1 in addition to how straight the outer surface and the camera 1. The determination unit 63b determines that it is possible to measure the depth of the tire groove 90 when the distance between the camera 1 and the outer surface of the tread part 9a is within a predetermined range (e.g., a range of about 10 cm-30 cm).

The determination unit 63b outputs a notification, indicating that the determination result indicates that measure of the depth of the tire groove 90 is possible, to the alert unit 61. The alert unit 61 outputs, as described above, an alert by using a mark, etc. displayed on the display device to indicate that it is possible to measure the depth of the tire groove 90. The user operation unit 62 acknowledges a user operation input from the worker to start measurement and outputs the input to the groove depth calculation unit 63c. The user operation unit 62 may not acknowledge a user operation input from the worker to start measurement until the determination unit 63b determines that it is possible to measure the depth of the tire groove 90.

The groove depth calculation unit 63c is triggered by a user operation input from the worker for starting measurement to calculate the depth of the tire groove 90 based on the three-dimensional position of the outer surface of the tread part 9a calculated by the straightness calculation unit 63a. The groove depth calculation unit 63c may calculate the depth of a portion of the tire groove 90 in the front direction facing the camera 1 or calculate the depth in multiple locations in the vicinity of the front direction facing the camera 1 and calculate the depth of the tire groove 90 by averaging the results.

The groove depth calculation unit 63c outputs the depth of the tire groove 90 thus calculated to the alert unit 61, and the alert unit 61 alerts the worker by displaying the depth of the tire groove 90 calculated on the display device, etc.

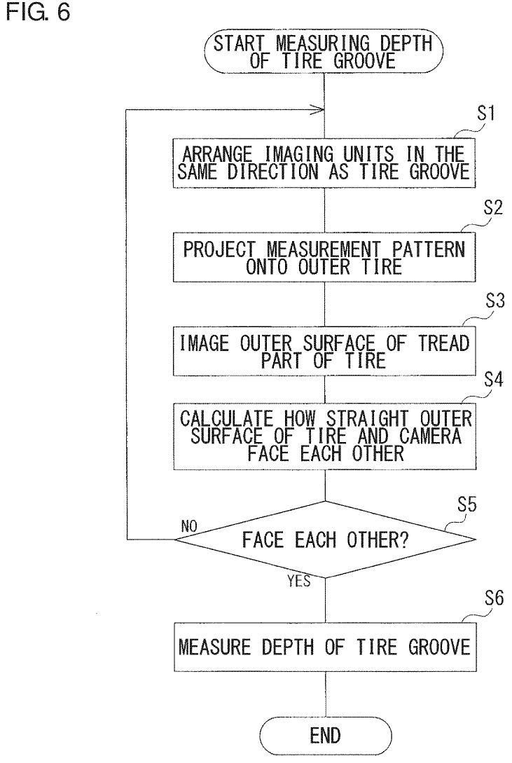

A description will now be given of the operation of the tire groove measurement device 100. FIG. 6 is a flowchart showing a sequence of steps for measuring the depth of the tire groove 90 by the tire groove measurement device 100. The tire groove measurement device 100 is arranged such that the two imaging units 3 of the camera 1 are arranged in the same direction as the direction in which the tire groove 90 extends (S1). The projector 2 of the camera 1 projects a measurement pattern onto the outer surface of the tread part 9a of the tire 9 (S2).

The measurement pattern from the projector 2 appears on the outer surface of the tread part 9a, and the two imaging units 3 image the outer surface of the tread part 9a (S3). The image data for the outer surface of the tread part 9a of the tire 9 captured by the imaging units 3 is input to the straightness calculation unit 63a of the control unit 63.

The straightness calculation unit 63a calculates the three-dimensional position of the outer surface of the tread part 9a according to the principle of a stereo camera, based on the input image data. The straightness calculation unit 63a calculates how straight the outer surface of the tire 9 and the camera 1 face each other by calculating the amount of displacement of the normal direction of the outer surface of the tread part 9a relative to the front direction facing the camera 1 (S4).

The determination unit 63b determines whether the outer surface of the tire 9 and the camera 1 face each other straight (S5). In step S5, the determination unit 63b determines whether the amount of displacement of the normal direction of the outer surface of the tread part 9a relative to the front direction facing the camera 1, which indicates how straight the outer surface of the tread part 9a and the camera 1 face each other, is smaller than a predetermined value.

When the result of determination in step S5 is negative (S5: NO), control returns to step S1, and step S1 through step S4 for calculating how straight the outer surface of the tire 9 and the camera 1 face each other are repeated. When the result of determination in step S5 is negative, the determination unit 63b may cause the alert unit 61 to alert that the tire and the camera do not face each other straight so as to prompt the worker to change the arrangement and posture of the camera 1.

When the result of determination in step S5 indicates that the outer surface of the tire 9 and the camera 1 face each other straight (S5: YES), the groove depth calculation unit 63c calculates the depth of the tire groove 90 based on the three-dimensional position of the outer surface of the tread part 9a (S6), and the process is terminated.

When it is determined that the outer surface of the tire 9 and the camera 1 face each other straight, the tire groove measurement device 100 calculates the depth of the tire groove 90. This allows the tire groove measurement device 100 to reduce an error in calculation of the depth of the tire groove 90 created when the front direction facing the camera 1 and the normal direction of the outer surface of the tread part 9a are displaced significantly. Further, by using image data captured by the two imaging units 3 arranged in the same direction in which the tire groove 90 extends, the tire groove measurement device 100 can reduce a blind area on the bottom part 91 of the tire groove 90 and improve the precision of measurement of the depth of the tire groove 90.

When it is determined that the camera and the tire face each other straight in the determination in step S5, the determination unit 63b may further determine whether the distance between the camera 1 and the outer surface of the tread part 9a in the front direction facing the camera 1 is within a predetermined range and may determine that it is possible to measure the depth of the tire groove 90 when the distance is within the predetermined range. When the distance between the camera 1 and the outer surface of the tread part 9a is within a suitable range, the tire groove measurement device 100 can calculate the stereoscopic position of the outer surface of the tread part 9a precisely.

By causing the alert unit 61 to alert that it is possible to measure the depth of the tire groove 90 in response to the result of determination by the determination unit 63b, the tire groove measurement device 100 can let the worker know that it is possible to measure the depth of the tire groove 90. The worker can measure the depth of the tire groove 90 by manipulating the user operation unit 62 based on the alert from the alert unit 61 indicating that it is possible to measure the depth of the tire groove 90. Further, in the absence of the alert indicating that it is possible to measure the depth of the tire groove 90, the worker can change the arrangement and posture of the camera 1 to make it possible to measure the depth of the tire groove 90.

The tire groove measurement device 100 is configured such that the camera 1 is attached to one end of the rod-shaped support 5. By holding the other end of the support 5 with the hand and using the device such that the one end of the support 5 is provided directly in front of the tread part 9a of the tire 9, the work of measuring the depth of the tire groove 90 is facilitated.

### (Variation)

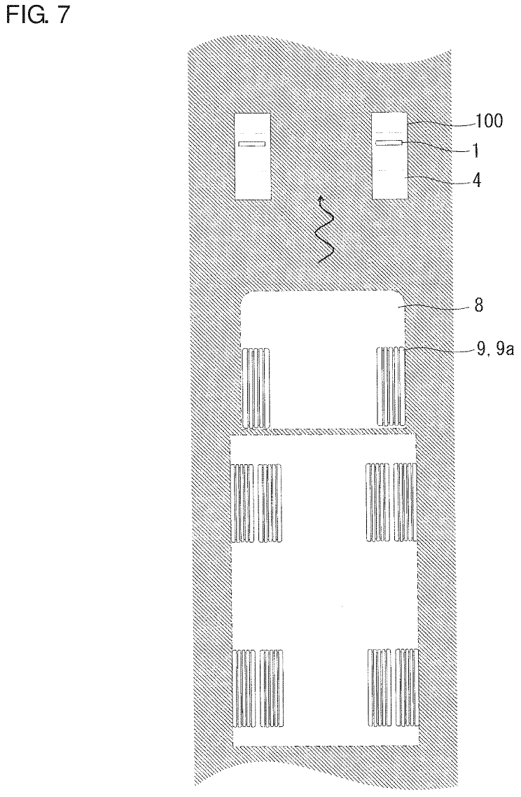

FIG. 7 is a schematic diagram showing an appearance of the tire groove measurement device 100 according to a variation. The tire groove measurement device 100 according to the variation is provided with a main body part 4 having a top surface that the tread part 9a of the tire 9, which moves as the vehicle 8 travels, comes into contact with and passes. The main body part 4 of the tire groove measurement device 100 is provided on the ground that the vehicle 8 travels.

The camera 1 of the tire groove measurement device 100 is provided in the main body part 4. The camera 1 is provided such that the projector 2 and the imaging units 3 face the outer surface of the tread part 9a of the tire 9 when the tire 9 comes into contact with and passes the top surface of the main body part 4. Further, the camera 1 is arranged such that two imaging units 3 are provided at an interval in the direction of travel of the vehicle.

The tire groove measurement device 100 images the outer surface of the tread part 9a of the tire 9 by using the two imaging units 3 while the tire 9 is in contact with the top surface of the main body part 4 and the projector 2 and the imaging units 3 of the camera 1 face the tire 9. As in the foregoing embodiment, the tire groove measurement device 100 determines whether the outer surface of the tire 9 and the camera 1 face each other straight based on the image data output by the two imaging units 3 and calculates the depth of the tire groove 90 when they face each other straight.

In the embodiment described above, an example is given where the tire groove measurement device 100 measures the depth of the tire groove 90 extending in the circumferential direction, which is the primary tire groove in the tread part 9a of the tire 9. However, the embodiment is applicable to a tire groove extending in a direction intersecting the circumferential direction of the tire 9.

Also, an example is given of the camera 1 of the tire groove measurement device 100 in which the projector 2 is provided between the two imaging units 3, but the relative positions of the two imaging units 3 and the projector 2 are not limited to those of the example.

Further, the support may be configured to expand or contract in the longitudinal direction or may be foldable to become more compact. Alternatively, the measurement unit 6 may be detachably mounted on the other end of the support 5 (the camera 1 is provided at the one end).

A description will now be given of the features of the tire groove measurement device 100 and the tire groove measurement method according to the embodiment.

The tire groove measurement device 100 includes the camera 1, the straightness calculation unit 63a as a calculation unit, and the determination unit 63b. The camera includes the projector 2 for projecting a measurement pattern onto the tire 9 and the two imaging units 3 arranged in the same direction as a direction in which the tire groove 90 extends. The straightness calculation unit 63a calculates how straight the outer surface of the tire 9 and the camera 1 face each other based on an image captured by the imaging units 3. The determination unit 63b determines whether the outer surface of the tire 9 and the camera 1 face each other straight based on a result of calculation by the straightness calculation unit 63a. This allows the tire groove measurement device 100 to reduce an error in calculation of the depth of the tire groove 90.

Further, the determination unit 63b determines whether a distance between the outer surface of the tire 9 and the camera 1 is within a predetermined range. When the distance between the camera 1 and the outer surface of the tire 9 is within a suitable range, the tire groove measurement device 100 can calculate the stereoscopic position of the outer surface of the tire 9 precisely.

Further, the tire groove measurement device 100 further includes: an alert unit 61 that outputs an alert indicating that it is possible to measure the tire groove 90 when the determination unit 63b determines that the outer surface of the tire and the camera face each other straight. This allows the tire groove measurement device 100 to let the worker know that it is possible to measure the depth of the tire groove 90.

The tire groove measurement device 100 further includes: a rod-shaped support 5 provided with the camera 1 at one end of the support; and a measurement unit 6 communicably connected to the camera 1. This allows the tire groove measurement device 100 to facilitate the work of measuring the depth of the tire groove 90.

A tire groove measurement method includes: imaging, calculating, and determining. The imaging includes imaging, by two imaging units 3 in a camera 1, an outer surface of a tire 9 by projection from a projector 2 in the camera 1, the imaging units 3 being arranged in the same direction as a tire groove, and the projector 2 projecting a measurement pattern onto the tire 9. The calculating includes calculating how straight the outer surface of the tire 9 and the camera 1 face each other based on an image captured in the imaging. The determining includes determining whether the outer surface of the tire 9 and the camera 1 face each other straight based on a result of calculation by the calculating. According to this tire groove measurement method, an error in calculation of the depth of the tire groove 90 is reduced.

Given above is an explanation based on an exemplary embodiment. The embodiments are intended to be illustrative only and it will be understood to those skilled in the art that variations and modifications are possible within the claim scope of the present invention and that such variations and modifications are also within the claim scope of the present invention. Therefore, the description in this specification and the drawings shall be treated to serve illustrative purposes and shall not limit the scope of the invention.

What is claimed is:

1. A tire groove measurement device comprising:
a camera that includes a projector for projecting a measurement pattern onto a tire and two imaging units arranged in the same direction as a direction in which a tire groove extends;
a calculation unit that calculates how straight an outer surface of the tire and the camera face each other based on an image captured by the imaging units; and
a determination unit that determines whether the outer surface of the tire and the camera face each other straight based on a result of calculation by the calculation unit.

2. The tire groove measurement device according to claim 1, wherein
the determination unit determines whether a distance between the outer surface of the tire and the camera is within a predetermined range.

3. The tire groove measurement device according to claim 1, further comprising:
an alert unit that outputs an alert indicating that it is possible to measure the tire groove when the determination unit determines that the outer surface of the tire and the camera face each other straight.

4. The tire groove measurement device according to claim 1, further comprising:
a rod-shaped support provided with the camera at one end of the support; and
a measurement unit communicably connected to the camera.

5. A tire groove measurement method comprising:
imaging, by two imaging units in a camera, an outer surface of a tire by projection from a projector in the camera, the imaging units being arranged in the same direction as a tire groove, and the projector projecting a measurement pattern onto the tire;
calculating how straight the outer surface of the tire and the camera face each other based on an image captured in the imaging; and
determining whether the outer surface of the tire and the camera face each other straight based on a result of calculation by the calculating.
